(19) United States
(12) Patent Application Publication
(10) Pub. No.: US 2014/0322385 A1
(43) Pub. Date: Oct. 30, 2014

(54) DEGRADABLE CHEWING GUM AND METHOD OF MAKING THE SAME

(71) Applicants: Graham T. Street, Birmingham (GB); Lawrence W. Harris, Birmingham (GB); Bryony Graham, Wigton (GB); Paul D. Soper, Beaconsfield (GB); Gaelle Buffet, Wokingham (GB)

(72) Inventors: Graham T. Street, Birmingham (GB); Lawrence W. Harris, Birmingham (GB); Bryony Graham, Wigton (GB); Paul D. Soper, Beaconsfield (GB); Gaelle Buffet, Wokingham (GB)

(73) Assignee: Intercontinental Great Brands LLC, East Hanover, NJ (US)

(21) Appl. No.: 14/241,904

(22) PCT Filed: Aug. 20, 2012
(86) PCT No.: PCT/US2012/051556

§ 371 Date: Mar. 26, 2014

Related U.S. Application Data
(60) Provisional application No. 61/530,054, filed on Sep. 1, 2011.

(51) Int. Cl. A23G 4/08

(52) U.S. Cl. CPC A23G 4/08
USPC 426/3

(57) ABSTRACT

A degradable chewing gum composition including about 5 to about 90 weight percent of a water-insoluble gum base and about 0.1 to about 15 weight percent of an alternating copolymer of maleic anhydride and a C₂-C₁₀ alkene is described. The alternating copolymer facilitates environmental degradation of improperly disposed chewing gum cuds. Also described is a method of preparing the chewing gum composition.

### BACKGROUND OF THE INVENTION

Chewing gums generally contain a water-insoluble gum base, as well as additional ingredients such as sweeteners or flavors tailored to provide specific sensory and physical characteristics. The water-insoluble gum base provides the desired chewy and tacky properties to the chewing gum.

Improperly disposed chewing gum cuds can adhere to the ground and other surfaces, where they are typically resistant to environmental degradation. Such gum litter is a nuisance, and its removal can be difficult and expensive.

When a chewing gum is being chewed, it is desirable that the gum maintains its viscoelastic nature. However, the stickiness and elastic properties become undesirable when the chewed gum is discarded. Some researchers have attributed the sticky properties of the chewing gum to the solvent used for dissolving elastomers while making the gum base and proposed excluding the solvent from gum base. For example, U.S. Pat. No. 5,882,702 to Abdel-Malik et al. obviates the need for elastomer solvents by replacing elastomers with a plasticized proteinaceous material such as zein. The incorporation of a plasticized proteinaceous material in chewing gum products, however, often compromises taste and thus can be undesirable from a consumer acceptability standpoint.

Furthermore, gum products that do not stick to teeth or oral prosthetics have been reported in U.S. Pat. No. 4,518,615 to Cherukuri et al. However, these gum products still do not solve the problem of discarded chewing gum cuds, which remain sticky enough to adhere to environmental surfaces and slow to degrade.

There is a need, therefore, for chewing gum compositions that degrade when exposed to environmental factors including humidity, rain, and snow, as well as footfall and other physical factors. Also, any solution proposed to address the above problem should not adversely affect the taste, chewy nature, or release profile of the chewing gum compositions.

### BRIEF DESCRIPTION OF EMBODIMENTS OF THE INVENTION

One embodiment is a degradable chewing gum composition comprising about 5 to about 90 weight percent of a water-insoluble gum base; and about 0.1 to about 15 weight percent of an alternating copolymer of a C₂-C₁₀ alkene and maleic anhydride; wherein all weight percents are based on the total weight of the chewing gum composition.

Another embodiment is a method of preparing a degradable chewing gum, the method comprising blending about 5 to about 90 weight percent of a water-insoluble gum base, about 0.1 to about 15 weight percent of an alternating copolymer of a C₂-C₁₀ alkene and maleic anhydride, and about 5 to about 50 weight percent of one or more additional ingredients selected from the group consisting of sweetening agents, flavor modulators, flavor potentiators, flavorants, aroma agents, coolants, warming agents, coloring agents, breath fresheners, mouth moisteners, humectants, acidulants, buffering agents, tingling agents, oral care agents, throat care agents, medicaments, antioxidants, preservatives, and combinations thereof, wherein all weight percents are based on the total weight of the chewing gum composition.

These and other embodiments are described in detail below.

### BRIEF DESCRIPTION OF THE FIGURES

FIG. 1 is an image of chewed cuds of comparative chewing gum (two left cuds) and inventive chewing gum (two right cuds) after 7 days on a wet indoor concrete slab.

FIG. 2 is an enlarged image of the upper right chewed cud of FIG. 1, wherein some hydrogel formation is indicated by the arrows.

FIG. 3 is a plot of grams of water absorbed as a function of days of environmental exposure for a chewed cud of Example 1 chewing gum, as well as images of the chewed cud at the respective time point.

FIG. 4 is a plot of grams of water absorbed as a function of days of environmental exposure for a Comparison 1 chewing gum and an Example 1 chewing gum.

### DETAILED DESCRIPTION OF THE INVENTION

As used herein, the term “degradable” refers to the tendency of a deposited gum base or chewed cud to break up in the environment due the effect of environmental factors such as rain, sun, frost, and due to cycling weather conditions. The environmental factors contributing to degradation also include footfall, sweeping, cleaning processes and/or detergents.

The present inventors have surprisingly found that presence of an alternating copolymer of an alkene and maleic anhydride in a chewing gum composition provides degradation properties to the chewing gum. The inventors found that a chewed cud of a chewing gum composition comprising about 0.1 to about 15 weight percent of an alternating copolymer of a C₂-C₁₀ alkene and maleic anhydride absorbs significantly more water as compared to a chewing gum lacking such alternating copolymer. After absorbing a large amount of water the chewed cuds becomes susceptible to degradation upon physical abuse such as footfall or sweeping. A chewing gum containing the alternating copolymer degrades faster than an ordinary chewing gum product lacking the alternating copolymer.

In some embodiments, there is provided a chewing gum composition comprising about 5 to about 90 weight percent of a water-insoluble gum base; and about 0.1 to about 15 weight percent of an alternating copolymer of a C₂-C₁₀ alkene and maleic anhydride; wherein all weight percents are based on the total weight of the chewing gum composition.

The alternating copolymer of a C₂-C₁₀ alkene and maleic anhydride is present in an amount sufficient to provide degradation properties to chewed cud of the chewing gum. Within the range of about 0.1 to about 15 weight percent, the copolymer weight can be about 0.5 to about 8 weight percent, specifically the copolymer weight can be about 1 to about 5 weight percent, more specifically the copolymer weight can be about 2 to about 4 weight percent.

The alternating copolymer of a C₂-C₁₀ alkene and maleic anhydride can have a suitable molecular weight sufficient to provide degradation properties to chewed cud of the chewing gum. In some embodiments, the chewing gum comprises an alternating copolymer of a C₂-C₁₀ alkene and maleic anhydride having a weight average molecular weight of about 10,000 to 3,000,000 atomic mass units. Within the range of 10,000 to 3,000,000, the molecular weight can be 50,000 to 2,000,000 atomic mass units, and specifically the molecular weight can be 100,000 to 1,500,000 atomic mass units.

The alternating copolymer of a C₂-C₁₀ alkene and maleic anhydride can be a copolymer of any C₂-C₁₀ alkene or a mixture of C₂-C₁₀ alkenes. In some embodiments, the chewing gum comprises of a copolymer of an alkene selected from the group consisting of ethylene, propylene, 1-butene, 1-pentene, 1-hexene, 1-heptene, 1-octene, 1-nonene, 1-decene, and combinations thereof. In some embodiments, the alternating copolymer is a copolymer of ethylene and maleic anhydride.

In some embodiments, the chewing gum composition comprises about 1 to about 5 weight percent of the alternating copolymer, and the C₂-C₁₀ alkene comprises ethylene.

As used herein, the term “alternating copolymer” refers to a copolymer consisting essentially of alternating residues derived from C₂-C₁₀ alkene and maleic anhydride. For example, when the C₂-C₁₀ alkene is ethylene, the alternating copolymer is a poly(ethylene-alt-maleic anhydride) comprising a plurality of repeating units having the structure

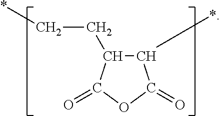

It will be understood that the alternating copolymer is an essentially linear copolymer and thus distinguished from branched copolymers and graft copolymers. Because the alkene and maleic anhydride residues are alternating, the alternating copolymer is also distinguished from block copolymers in which each block contains the residue of a single monomer.

It will be understood that the term “alternating copolymer” encompasses species in which a small fraction, e.g., up to about 5 mole percent, of the maleic anhydride residues are hydrolyzed to a free acid or salt form. In some embodiments, the percentage of hydrolyzed maleic anhydride residues is up to about 3 mole percent, specifically up to about 2 mole percent, more specifically up to about 1 mole percent, based on the moles of maleic anhydride residues.

In some embodiments, the alternating copolymer of a C₂-C₁₀ alkene and maleic anhydride is present in a powder form comprising particles having mean particle size of about 1 micrometer to about 100 micrometers measured according to ASTM D1921-01. Within the range of 1 micrometer to 100 micrometers, the mean particle size can be about 2 micrometers to about 80 micrometers, specifically about 5 micrometers to 60 micrometers and more specifically about 10 micrometers to about 40 micrometers. In some embodiments, the alternating copolymer is poly(ethylene-alt-maleic anhydride) commercially available as a powder from Sigma-Aldrich (CAS number 9006-26-2), having weight average molecular weight of 100,000 to 500,000 and having a transition temperature (T_{g}) of 235 degree Celsius.

In some embodiments, the alternating copolymer of a C₂-C₁₀ alkene and maleic anhydride is present in an encapsulated form. Encapsulation may be desirable to prevent premature degradation of the chewing gum prior to mastication. The alternating copolymer may be encapsulated as microcapsules or micro-particles as described in PCT Publication No. WO 2004/064544 of Lavoie et al., which is incorporated herein by reference in its entirety. Suitable encapsulants include, but are not limited to fats, polymers, carbohydrates, and combinations thereof. A particularly suitable encapsulant is polyethylene wax, for example a polyethylene wax available from Honeywell Inc. under the trade name A-C 8A®, having a melting point of 113 degree Celsius.

Generally, the chewing gum composition comprises a water-insoluble gum base portion and a bulk portion comprising of additional ingredients (also known as additives). The gum base can vary greatly depending upon various factors such as the type of base desired, the consistency of gum desired, and the other components used in the composition to make the final chewing gum product. In some embodiments, the chewing gum base is present in an amount of about 5 to about 90 weight percent, where the weight percent is based on the total weight of the chewing gum composition. Within the range of about 5 to about 90, the water-insoluble gum base can be present in an amount of about 10 to about 50 weight percent, specifically the gum base can be present in an amount of about 15 to about 40 weight percent, and even more specifically the gum base can be present in an amount of about 20 to about 30 weight percent.

As used herein, the term “water-soluble” encompasses compounds, which possess a water solubility of at least 1 gram/liter at 25 degree Celsius. As used herein, the term “water-insoluble” encompasses compounds, which possess a water solubility of less than at least 1 gram/liter at 25 degree Celsius.

The gum base can be any water-insoluble gum base known in the art, and includes those gum bases utilized for chewing gums and bubble gums. Illustrative examples of suitable polymers in gum bases include both natural and synthetic elastomers and rubbers, for example, substances of vegetable origin such as chicle, crown gum, nispero, rosadinha, jelutong, perillo, niger gutta, tunu, balata, gutta-percha, lechi-capsi, sorva, gutta kay, and the like, and combinations thereof. Synthetic elastomers include high- and low-molecular weight elastomers. Useful high molecular weight elastomers include butadiene-styrene copolymers, polyisoprene, polyisobutylene, isobutylene-isoprene copolymers, polyethylene, combinations thereof, and the like. Useful low-molecular weight elastomers include polybutene, polybutadiene, polyisobutylene, and combinations thereof. Suitable gum bases can also include vinyl polymeric elastomers such as poly(vinyl acetate) (PVA), polyethylene, vinyl copolymeric elastomers such as copolymers of vinyl acetate and vinyl laurate, copolymers of vinyl acetate and vinyl stearate, copolymers of ethylene and vinyl acetate, poly(vinyl alcohol) and combinations thereof. When utilized, the weight average molecular weight of the vinyl polymers can range about 3,000 to about 94,000 atomic mass units. Vinyl polymers such as poly(vinyl alcohol) and poly(vinyl acetate) can have a weight average molecular weight of about 8,000 to about 65,000 atomic mass units. Furthermore, any combination of the aforementioned high- and low-molecular weight, natural and synthetic elastomers, and rubbers can be used as a gum base. The polymers can be present in an amount of about 35 to about 95 weight percent, based on the weight of the gum base.

The gum base composition can contain conventional elastomer plasticizers and softeners to aid in softening the elastomer base component. For example, plasticizers may include terpene resins such as polymers derived from alpha-pinene, beta-pinene, and/or d-limonene; methyl, glycerol or pentaerythritol esters of rosins or modified rosins and gums, such as hydrogenated, dimerized or polymerized rosins, or combinations comprising at least one of the foregoing resins; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like. Any combination of the foregoing elastomer plasticizers can be used to soften or adjust the tackiness of the elastomer base component. The elastomer plasticizer can be used in amounts of about 5 to about 75 weight percent of the gum base, specifically about 45 to about 70 weight percent of the gum base.

In some embodiments, the chewing gum composition further contains a gum base softener. In some embodiments, the softener is present in amounts of up to about 30 weight percent of the gum base, specifically about 3 to about 20 weight percent of the gum base. Suitable softeners include lanolin, palmitic acid, oleic acid, stearic acid, fatty acids, sodium stearate, potassium stearate, glyceryl triacetate, glyceryl lecithin, glyceryl monostearate, propylene glycol monostearate, mono-, di- and triglycerides, acetylated monoglyceride, glycerine, lecithin, diacetin, and combinations thereof. Other suitable softeners include waxes. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, cocoa butter, propylene glycol, and the like can also be incorporated into the gum base to obtain a variety of desirable textures and consistency properties. The waxes employed can have a melting point below about 60 degrees Celsius, and preferably about 45 to about 55 degrees Celsius. The low melting wax can be a paraffin wax. The wax can be present in the gum base in an amount about 6 to about 10 weight percent, and preferably about 7 to about 9.5 weight percent, based on the total weight of the gum base. In addition to the low melting point waxes, waxes having a higher melting point can be used in the gum base in amounts up to about 5 weight percent based on the weight of the gum base. Such high melting waxes include beeswax, vegetable wax, rice bran wax, candelilla wax, carnauba wax, polyethylene wax, microcrystalline wax, petroleum waxes, and the like, and mixtures thereof.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate and the like, which can serve as fillers and textural agents. These fillers or adjuvants can be used in the gum base in various amounts. Specifically the amount of filler, when used, will be present in an amount of about 15 to about 40 weight percent, specifically about 20 to about 30 weight percent, based on the weight of the gum base.

In addition to the gum base and the copolymer, the chewing gum composition may further comprising one or more additional ingredients selected from the group consisting of sweetening agents, flavor modulators or potentiators, flavorants, aroma agents, coolants, warming agents, coloring agents, breath fresheners, mouth moisteners, humectants, acidulants, buffering agents, tingling agents, oral care agents, throat care agents, medicaments, antioxidants, preservatives, and combinations thereof. Some of these additional ingredients can serve more than one purpose. For example, a sweetening agent such as sucrose, sorbitol, other sugar alcohols, and combinations thereof can also function as a bulking agent. A combination comprising at least one of the foregoing additional ingredients is often used.

In some embodiments, the chewing gum includes a sweetening agent to provide a sweet taste to the gum composition. Sweetening agents can include sugar sweeteners, sugarless sweeteners, high intensity sweeteners, or a combination of at least two of the foregoing sweetening agents.

Sugar sweeteners generally include saccharides. Suitable sugar sweeteners include monosaccharides, disaccharides and polysaccharides such as sucrose (sugar), dextrose, maltose, dextrin, xylose, ribose, glucose, mannose, galactose, fructose (levulose), lactose, invert sugar, fructooligosaccharide syrups, partially hydrolyzed starch, corn syrup solids, such as high fructose corn syrup, and combinations thereof.

Suitable sugarless sweeteners include sugar alcohols (or polyols) such as sorbitol, xylitol, mannitol, galactitol, maltitol, hydrogenated isomaltulose (isomalt), lactitol, erythritol, hydrogenated starch hydrolysate, and combinations thereof. Suitable hydrogenated starch hydrolysates include those disclosed in U.S. Pat. No. 4,279,931 to Verwaerde et al. and various hydrogenated glucose syrups and/or powders, which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN™, a line of commercially available products manufactured by Roquette Freres of France, and HYSTAR™, a line of commercially available products manufactured by Lonza, Inc., of Fair Lawn, N.J., USA.

A “high intensity sweetener” as used herein means agents having a sweetness at least 100 times that of sugar (sucrose) on a per weight basis, specifically at least 500 times that of sugar on a per weight basis. In some embodiments the high intensity sweetener is at least 1,000 times that of sugar on a per weight basis, more specifically at least 5,000 times that of sugar on a per weight basis. The high intensity sweetener can be selected from a wide range of materials, including water-soluble natural and artificial sweeteners, derivatives of water-soluble sweeteners, dipeptide based sweeteners, and protein based sweeteners. Any combination comprising two or more high intensity sweetener can be used. One or more of the high intensity sweeteners can further be combined with one or more of the foregoing sweeteners or sweetening agents. The high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, and combinations of the foregoing forms.

Without being limited to particular sweetening agents, representative categories and examples include (1) water-soluble sweetening agents such as dihydrochalcones, monellin, steviosides, Rebaudioside A, Rebaudioside B, Rebaudioside C, glycyrrhizin, dihydroflavenol, and sugar alcohols such as sorbitol, mannitol, maltitol, monatin, and L-aminodicarboxylic acid aminoalkenoic acid ester amides, such as those disclosed in U.S. Pat. No. 4,619,834 to Zanno et al., or a combination comprising at least one of the foregoing; (2) water-soluble artificial sweeteners such as saccharin, soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination comprising at least one of the foregoing; (3) dipeptide based sweeteners, for example the L-aspartic acid derived sweeteners such as L-aspartyl-L-phenylalanine methyl ester (Aspartame) and materials described in U.S. Pat. No. 3,492,131 to Schlatter et al., L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenyl-glycine, L-alpha-aspartyl-L-phenylglycine methyl ester, L-alpha-aspartyl-L-2,5-dihydrophenylglycine methyl ester, L-aspartyl-2,5-dihydro-L-phenylalanine; L-alpha-aspartyl-2,5-dihydrophenylalanine methyl ester, L-aspartyl-L-(1-cyclohexen)-alanine, N-(N-(3,3-dimethylbutyl)-L-alpha-aspartyl)-L-phenylalamine methyl ester (Neotame), or a combination thereof; (4) derivatives of water-soluble sweeteners, such as derivatives of steviosides, derivatives of Rebaudioside A, derivatives of Rebaudioside B, derivatives of Rebaudioside C, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include 1-chloro-1′-deoxysucrose; 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose; 1,6-dichloro-1,6-dideoxy-β-D-fructofuranosyl-4-chloro-4-deoxy-α-D-galactopyranoside; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6,1′,6′-tetradeoxygalacto-sucrose; 4,6,1′,6′-tetradeoxy-sucrose, or a combination thereof; (5) protein based sweeteners such as thaumaoccous danielli, thaumatin, talin, or a combination thereof; and (6) amino acid based sweeteners.

In some embodiments, the sweeteners include sorbitol, mannitol, aspartame, acesulfame potassium salt, and combinations thereof. The sweeteners can be present in a suitable amount depending upon the desired level of sweetness. In some embodiments the sweeteners are present in an amount of about 35 to about 80 weight percent of the chewing gum composition. Within the range of about 35 to about 80, the amount can be about 45 to about 75 weight percent, specifically, the amount can be about 50 to 65 weight percent.

In a chewing gum product, a sweet taste can also come from flavor modulators or potentiators and/or from flavorants. Flavor modulators can impart a characteristic of their own that complements or negates a characteristic of another component. For example, flavors can be compounded to have additional sweet notes by the inclusion of flavor modulators or potentiators, such as vanilla, vanillin, ethyl maltol, furfural, ethyl propionate, lactones, and a combinations thereof. The flavor modulators can be used in the amount about 0.01 to about 30 weight percent of the gum composition depending on the desired intensity of the aromas used. Preferably, the content of the flavor modulators is in the range of about 0.2 to about 3 weight percent of the gum composition.

Flavor potentiators are materials that intensify, supplement, modify or enhance the taste or aroma perception of an original material without introducing a characteristic taste or aroma perception of their own. In some embodiments, flavor potentiators are designed to intensify, supplement, modify, or enhance the perception of flavor, sweetness, tartness, umami, kokumi, saltiness or a combination thereof. The flavor potentiators can be used in the amount about 0.01 to about 30 weight percent of the gum composition depending on the desired intensity of the aromas used. Preferably, the content of the flavor potentiators is in the range of about 0.2 to about 3 weight percent of the gum composition.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, phyllodulcin, vanilla extract, vanilla oleoresin, vanillin, sugar beet extract (alcoholic extract), sugarcane leaf essence (alcoholic extract), compounds that respond to G-protein coupled receptors (T2Rs and T1Rs), and combinations thereof. In some embodiments, sugar acids, sodium chloride, potassium chloride, sodium acid sulfate, or a combination comprising at least one of the foregoing are used. In other embodiments, glutamates such as monosodium glutamate, monopotassium glutamate, hydrolyzed vegetable protein, hydrolyzed animal protein, yeast extract, and combinations thereof are included. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

Flavorants (also known as flavorings, flavors or flavoring agents) that can be used include those artificial and natural flavors known in the art, for example synthetic flavor oils, natural flavoring aromatics and/or oils, oleoresins, extracts derived from plants, leaves, flowers, fruits, and the like, and combinations comprising at least one of the foregoing flavorants. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, and combinations thereof. Specific flavorants are mints such as peppermint, spearmint, artificial vanilla, cinnamon derivatives, and various fruit flavors.

Examples of artificial, natural, and synthetic fruit flavorants include coconut, coffee, chocolate, vanilla, lemon, grapefruit, orange, lime, yazu, sudachi, menthol, licorice, caramel, honey, peanut, walnut, cashew, hazelnut, almonds, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and the like, and combinations thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), 2-dodecenal (citrus, mandarin), and combinations thereof.

Other potential flavors whose release profiles can be managed include a milk flavor, a butter flavor, a cheese flavor, a cream flavor, a yogurt flavor, a vanilla flavor, a tea or coffee flavor, such as a green tea flavor, a oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, Zanthoxyli Fructus, perilla, juniper berry, ginger, star anise, horseradish, thyme, a tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, tomato, and any combinations thereof. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the composition can further include fruit juices.

The flavoring agents can be used in many distinct physical forms. Such physical forms include liquid and/or dried form. In some embodiments, the flavoring agents can be in free (unencapsulated) forms, spray dried forms, freeze dried forms, powdered forms, beaded forms, encapsulated forms, slices, pieces, and mixtures thereof. When employed in a spray-dried form, suitable drying means such as spray-drying a liquid can be used. Alternatively, the flavoring agent can be absorbed onto water-soluble materials, such as cellulose, starch, sugar, maltodextrin, gum arabic and so forth or it can be encapsulated. In still other embodiments, the flavoring agent can be adsorbed onto silicas, zeolites, and the like. The particle size of the flavoring agents can be less than 3 millimeters, less than 2 millimeters or preferably less than 1 millimeter, calculated as the longest dimension of the particle. The natural flavoring agent can have a particle size about 3 micrometers to 2 millimeters, specifically about 4 micrometers to about 1 millimeter. The flavorants can be used in the amount about 0.01 to about 30 weight percent of the gum composition depending on the desired intensity of the aromas used. Preferably, the content of the flavorants is in the range of about 0.2 to about 3 weight percent of the gum composition.

The amount of flavor modulators, flavor potentiators, and flavorants used herein can be a matter of preference subject to such factors as the type of final chewing gum product composition, the individual flavor, the gum base employed, and the strength of flavor desired. Thus, the amount of flavorants can be varied in order to obtain the result desired in the final product and such variations are within the capabilities of those skilled in the art without the need for undue experimentation.

In some embodiments, the chewing gum contains aroma agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The aroma agents can be in liquid or powdered form. The aroma agents can be used in the amount about 0.01 to about 30 weight percent of the gum composition depending on the desired intensity of the aromas used. Preferably, the content of the aroma agents is in the range of about 0.2 to about 3 weight percent of the gum composition.

Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2-propyl)-5-methyl-1-cyclohexanol) is available in artificial form, or naturally from sources such as peppermint oil. Menthol derivatives include menthyl ester-based and menthyl carboxamide-based cooling compounds such as menthyl carboxamide, N-ethyl-p-menthane carboxamide, monomenthyl succinate, monomenthyl methyl succinate, monomenthyl glutarate, menthyl 2-pyrrolidone-5-carboxylate, monomenthyl 3-methyl maleate, menthyl acetate, menthyl lactate, menthyl salicylate, 2-isopropanyl-5-methylcyclohexanol, 3-L-menthoxypropane-1,2-diol, menthane, menthone, menthone ketals, menthone glycerol ketals, menthyl glutarate esters, N-ethyl-p-menthane-3-carboxamide (WS-3), or a combination thereof. Additional menthyl-based coolants, specifically menthylcarboxamides, are described in U.S. Pat. No. 7,923,577 to Bardsley et al.

Other cooling agents that can be used in combination with or in the absence of the menthyl-based coolants include, for example 2-mercapto-cyclo-decanone, hydroxycarboxylic acids with 2 to 6 carbon atoms, xylitol, erythritol, alpha-dimethyl succinate, menthyl lactate, acyclic carboxamides such as N-2,3-trimethyl-2-isopropyl butanamide, and combinations thereof. Additional cooling agents include the 1-tert-butylcyclohexanecarboxamides described in U.S. Patent Application Publication Nos. US 2011/0070171 A1 and US 2011/0070329 A1 of Kazimierski et al.

Cooling compositions comprising a primary cooling compound, a secondary cooling compound, and an ingestible non-polar solvent are described in U.S. Patent Application Publication No. US 2011/0091531 A1 of Furrer et al. The cooling agents can be present in a suitable amount depending upon the desired level of cooling intensity. In some embodiments, the cooling agents are present in an amount of about 0.01 to about 1.5 weight percent of the chewing gum composition. Within the range of about 0.01 to about 1.5 weight percent, the cooling agents can be about 0.05 to about 1.25 weight percent, specifically the cooling agents can be about 0.1 to 1 weight percent.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumary Company Limited, Tokyo, Japan, vanillyl alcohol methyl ether, vanillyl alcohol ethyl ether, vanillyl alcohol n-propyl ether, vanillyl alcohol isopropyl ether, vanillyl alcohol isobutyl ether, vanillyl alcohol n-pentyl ether, vanillyl alcohol isoamyl ether, vanillyl alcohol n-hexylether, gingerol, shogaol, paradol, zingerone, capsaicin, dihydrocapsaicin, nordihydrocapsaicin, homocapsaicin, homodihydrocapsaicin, ethanol, isopropyl alcohol, isoamyl alcohol, benzyl alcohol, glycerin, and combinations thereof. The warming agents can be present in a suitable amount depending upon the desired level of warming intensity. In some embodiments, the warming agents are present in an amount of about 0.01 to about 1.5 weight percent of the chewing gum composition. Within the range of about 0.01 to about 1.5 weight percent, the warming agents can be about 0.05 to about 1.25 weight percent, specifically the warming agents can be about 0.1 to 1 weight percent.

Coloring agents (also known as colorants or colorings) can be used in amounts effective to produce a desired color for the chewing gum. Suitable coloring agents include pigments, which can be incorporated in amounts up to about 6 weight percent by weight of the chewing gum. For example, titanium dioxide can be incorporated in amounts of about 0.1 to about 2 weight percent and specifically about 0.15 to about 1 weight percent by weight of the chewing gum. Suitable coloring agents also include natural food colors and dyes suitable for food, drug, and cosmetic applications.

Suitable colorants include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), FD&C aluminum lakes, and combinations thereof. The coloring agents can be present in a suitable amount depending upon the desired level of coloring intensity. In some embodiments, the coloring agents are present in an amount of about 0.005 to about 1.25 weight percent of the chewing gum composition. Within the range of about 0.005 to about 1 weight percent, the coloring agents can be about 0.01 to about 1 weight percent, specifically the warming agents can be about 0.02 to 0.8 weight percent.

Exemplary breath fresheners include zinc citrate, zinc acetate, zinc fluoride, zinc ammonium sulfate, zinc bromide, zinc iodide, zinc chloride, zinc nitrate, zinc fluorosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, and combinations thereof. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, and combinations thereof. Aldehydes such as cinnamic aldehyde and salicylaldehyde can be used. Additionally, chemicals such as menthol, carvone, iso-garrigol, and anethole can function as breath fresheners. The breath fresheners can be present in a suitable amount depending upon the desired level of intensity. In some embodiments, the breath fresheners are present in an amount of about 0.01 to about 2 weight percent of the chewing gum composition. Within the range of about 0.01 to about 2 weight percent, the breath fresheners can be about 0.05 to about 1.25 weight percent; specifically, the breath fresheners can be about 0.1 to 1 weight percent.

Exemplary mouth moisteners include saliva stimulators such as acids and salts including acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and salts of the foregoing acids. Mouth moisteners can include hydrocolloid materials that hydrate and can adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination thereof. Modified celluloses can be included such as microcrystalline cellulose, carboxymethylcellulose (CMC), methylcellulose (MC), hydroxypropylmethylcellulose (HPMC), hydroxypropylcellulose (MPC), or a combination thereof. The mouth moisteners can be present in a suitable amount depending upon the desired level of intensity. In some embodiments, the mouth moisteners are present in an amount of about 0.01 to about 2 weight percent of the chewing gum composition. Within the range of about 0.01 to about 2 weight percent, the mouth moisteners can be about 0.05 to about 1.25 weight percent; specifically, the mouth moisteners can be about 0.1 to 1 weight percent.

Similarly, humectants, which can provide a perception of mouth hydration, can be included. Such humectants can include glycerol, sorbitol, polyethylene glycol, erythritol, xylitol, and combinations thereof. Additionally, in some embodiments, fats can provide a perception of mouth moistening. Such fats can include medium chain triglycerides, vegetable oils, fish oils, mineral oils, and combinations thereof. The humectants can be present in a suitable amount depending upon the desired level of intensity. In some embodiments, the humectants are present in an amount of about 0.01 to about 2 weight percent of the chewing gum composition. Within the range of about 0.01 to about 2 weight percent, the humectants can be about 0.05 to about 1.25 weight percent; specifically, the humectants can be about 0.1 to 1 weight percent.

Suitable acidulants illustratively include acetic acid, citric acid, fumaric acid, hydrochloric acid, lactic acid and nitric acid as well as sodium citrate, sodium bicarbonate, sodium carbonate, sodium or potassium phosphate, magnesium oxide, potassium metaphosphate, sodium acetate, and combinations thereof. The acidulants can be present in a suitable amount depending upon the desired level of intensity. In some embodiments, the acidulants are present in an amount of about 0.1 to about 3 weight percent of the chewing gum composition. Within the range of about 0.1 to about 3 weight percent, the acidulants can be about 0.5 to about 2.5 weight percent; specifically, the humectants can be about 0.75 to 2 weight percent.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof. The buffering agents can be present in a suitable amount depending upon the desired level of intensity. In some embodiments, the buffering agents are present in an amount of about 0.01 to about 2 weight percent of the chewing gum composition. Within the range of about 0.01 to about 2 weight percent, the buffering agents can be about 0.05 to about 1.25 weight percent; specifically, the buffering agents can be about 0.1 to 1 weight percent.

In some embodiments, a tingling sensation can be provided. Tingling agents include jambu, and alkylamides extracted from materials such as jambu or sanshool. Tingling agents can be present in a suitable amount depending upon the desired level of intensity. In some embodiments, the tingling agents are present in an amount of about 0.01 to about 2 weight percent of the chewing gum composition. Within the range of about 0.01 to about 2 weight percent, the tingling agents can be about 0.05 to about 1.25 weight percent; specifically, the tingling agents can be about 0.1 to 1 weight percent.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include, hydrolytic agents including proteolytic enzymes, abrasives such as hydrated silica, calcium carbonate, sodium bicarbonate and alumina, other active stain-removing components such as surface-active agents, including anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. Oral care ingredients can also include tetrasodium pyrophosphate and sodium tri-polyphosphate, sodium bicarbonate, sodium acid pyrophosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphospate, and combinations thereof. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents include detersive materials that impart to the composition detersive and foaming properties. Suitable surfactants include sodium stearate, sodium ricinoleate, sodium lauryl sulfate, water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolammonium salts of N-lauroyl sarcosine, N-myristoyl sarcosine, and N-palmitoyl sarcosine.

In addition to surfactants, oral care ingredients can include antibacterial agents such as triclosan, chlorhexidine, zinc citrate, silver nitrate, copper, limonene, cetyl pyridinium chloride, and combinations thereof.

Anticaries agents can include fluoride ion sources such as sodium fluoride, potassium fluoride, sodium fluorosilicate, ammonium fluorosilicate, potassium fluoride, sodium monofluorophosphate, stannous fluoride, potassium stannous fluoride, sodium hexafluorostannate, stannous chlorofluoride, and combinations thereof.

Further examples of anticaries agents are included in U.S. Pat. No. 5,227,154 to Reynolds, U.S. Pat. No. 5,378,131 to Greenberg, and U.S. Pat. No. 6,685,916 to Holme et al. Oral care agents can be present in a suitable amount depending upon the desired level of care. In some embodiments, the oral care agents are present in an amount of about 0.01 to about 2 weight percent of the chewing gum composition. Within the range of about 0.01 to about 2 weight percent, the oral care agents can be about 0.05 to about 1.25 weight percent; specifically, the oral care agents can be about 0.1 to 1 weight percent.

Throat care or throat-soothing ingredients include analgesics, antihistamines, anesthetics, demulcents, mucolytics, expectorants, antitussive, and antiseptics. In some embodiments, throat-soothing agents include honey, propolis, aloe vera, glycerine, menthol and a combination thereof is employed. Throat care agents can be present in a suitable amount depending upon the desired level of care. In some embodiments, the throat care agents are present in an amount of about 0.01 to about 2 weight percent of the chewing gum composition. Within the range of about 0.01 to about 2 weight percent, the throat care agents can be about 0.05 to about 1.25 weight percent; specifically, the throat care agents can be about 0.1 to 1 weight percent.

Medicaments can be included in the chewing gum product. Non-limiting illustrative categories and specific examples include antihistamines, decongestants (sympathomimetics), antitussives (cough suppressants), expectorants, anesthetics, analgesics, demulcents, antibacterial agents, antiviral agents, anti-inflammatories, antacids, antifungal agents, chemotherapeutics, diuretics, psychotherapeutic agents, homeopathic agents, anticholinergics, throat-soothing agents, antinauseants, cardiovascular agents, various alkaloids, laxatives, appetite suppressants, ACE-inhibitors, anti-asthmatics, anti-cholesterolemics, anti-depressants, anti-diarrhea preparations, anti-hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants, osteoporosis preparations, oxytocics, parasympatholytics, parasympathomimetics, prostaglandins, respiratory agents, sedatives, smoking cessation aids such as bromocryptine or nicotine, tremor preparations, urinary tract agents, anti-ulcer agents, anti-emetics, hyper- and hypo-glycemic agents, thyroid and anti-thyroid preparations, terine relaxants, erythropoietic drugs, mucolytics, DNA and genetic modifying drugs, and nutritional supplements, including nutraceuticals, micronutrients, vitamins and co-enzymes. The pharmaceutically acceptable salts and prodrugs of the medicaments are also included unless specified otherwise. Some of these medicaments can serve more than one purpose. Combinations of the foregoing types of optional medicaments can be used. Two or more medicaments that have activity against the same or different symptoms can be used together in a combination.

Medicaments for the treatment of a cough, or a cold or flu symptom include elements, compounds or materials, alone or in combination, that have been used for, or have been shown to be useful for, the amelioration of at least one symptom commonly associated with cough, colds, or influenza. It is to be understood that a “medicament for the treatment of a cough, or a cold or flu symptom” includes medicaments that are also useful for the treatment of cold-like or flu-like symptoms arising from other sources, such as allergies, adverse environmental conditions, and the like. Cold, cold-like, flu, and flu-like symptoms as used herein include cough, coryza, nasal congestion, upper respiratory infections, allergic rhinitis, otitis, sinusitis, sneezing, and the discomfort, pain, fever and general malaise associated with colds, flu, allergies, adverse environmental conditions, and the like.

Examples of general categories of medicaments for the treatment of a cough, or a cold or flu symptom include antihistamines, decongestants (sympathomimetics), antitussives (cough suppressants), anti-inflammatories, homeopathic agents, expectorants, anesthetics, demulcents, analgesics, anticholinergics, throat-soothing agents, antibacterial agents, and antiviral agents. Some of these medicaments can serve more than one purpose. The pharmaceutically acceptable salts and prodrugs of the medicaments are also included unless specified otherwise. Two or more medicaments that have activity against the same or different symptoms of colds or coughs can be used together in a combination.

Exemplary antihistamines include azatadine, bromodiphenhydramine, brompheniramine, brompheniramine maleate, carbinoxamine, carbinoxamine maleate, cimetidine, chlorpheniramine, chlorpheniramine maleate, dexchlorpheniramine, diphenhydramine, diphenhydramine hydrochloride, doxylamine, phenindamine, pheniramine, phenyltoloxamine, pyrilamine, promethazine, triprolidine, loratadine, ranitidine, chlorcyclizine, terfenadine, clemastine fumarate, dimenhydrinate, prilamine maleate, tripelennamine hydrochloride, tripelennamine citrate, hydroxyzine pamoate, hydroxyzine hydrochloride, cyclizine lactate, cyclizine hydrochloride, meclizine hydrochloride, acrivastine, cetirizine hydrochloride, astemizole, levocabastine hydrochloride, cetirzine, and combinations thereof.

Exemplary decongestants include agents such as levopropoxyphene napsylate, noscapine, carbetapentane, caramiphen, chlophedianol, pseudoephedrine hydrochloride, phenylephrine, phenylpropanolamine, diphenhydramine, glaucine, pholcodine, benzonatate, ephedrine, ephinephrine, levodesoxyephedrine, oxymetazoline, naphazoline, propylhexedrine, xylometazoline, and combinations thereof.

Antitussives help relieve coughing. Examples of antitussives include codeine, dihydrocodeine, hydrocodone and hydromorphone, carbetapentane, caramiphen, hydrocodone bitartrate, chlorphedianol, noscarpine, dextromethorphan, and combinations thereof.

Expectorants include guaifenesin, aniseed, blood root, coltsfoot, elderflower, golden seal, grindelia, hyssop, lungwort, mullein, senega, thuja, thyme, vervain, glyceryl guaiacolate, terpin hydrate, N-acetylcysteine, bromhexine, ambroxol, domiodol, 3-iodo-1,2-propanediol and wild cherry, ammonium chloride, calcium iodide, iodinated glycerol, potassium guaiacolsulfonate, potassium iodide, sodium citrate, and combinations thereof.

Anaesthetics include etomidate, ketamine, propofol, and benodiazapines (e.g., chlordiazepoxide, diazepam, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocaine, procaine, proparcaine, ropivacaine, tetracaine, and combinations thereof. Other useful agents can include amobartital, aprobarbital, butabarbital, butalbital mephobarbital, methohexital, pentobarbital, phenobarbital, secobarbital, thiopental, paral, chloral hydrate, ethchlorvynol, clutethimide, methprylon, ethinamate, meprobamate, and combinations thereof.

Analgesics include opioids such as morphine, mepidine, dentanyl, sufentranil, alfentanil, aspirin, salicylamide, sodium salicylate, acetaminophen, ibuprofen, indomethacine, naproxen, atrin, isocome, midrin, axotal, firinal, phrenilin, ergot and ergot derivatives (wigraine, cafergot, ergostat, ergomar, dihydroergotamine), imitrex, and combinations thereof.

Anticholinergics include homatropine, atropine, scopolamine hydrogen bromide, L-hyoscyamine, L-alkaloids of belladonna, tincture of belladonna alkaloids, homatropine hydrogen bromide, homatropine methylbromide, methscopolamine, anisotropine, anisotropine with phenobarbital, clindinium, glycopyrrolate, hexocyclim, isopropamide, mepenzolate, methantheline, oxyphencyclimine, propantheline, tridihexethyl, dicyclomine, scopolamine, atropine, dicyclomine, flavoxate, ipratropium, oxybutynin, pirenzepine, tiotropium, tolterodine, tropicamide, trimethaphan, atracurium, doxacurium, mivacurium, pancuronium, tubocurarine, vecuronium, suxamethonium chloride, and combinations thereof.

Demulcents include coltsfoot, comfrey, corn silk, couchgrass, flaxseed, irish moss, lungwort, liquorice, mallow, marshmallow, mullein, oatmeal, parsley piert, slippery elm, and combinations thereof.

Antibacterial agents include those within the antibiotic classes of aminoglycosides, cephalosporins, macrolides, penicillins, quinolones, sulfonamides, and tetracyclines. Specific exemplary antibiotic agents include naficillin, oxacillin, vancomycin, clindamycin, erythromycin, trimethoprim-sulphamethoxazole, rifampin, ciprofloxacin, broad spectrum penicillin, amoxicillin, gentamicin, ceftriazoxone, cefotaxime, chloramphenicol, clavunate, sulbactam, probenecid, doxycycline, spectinomycin, cefixime, penicillin G, minocycline, β-lactamase inhibitors; meziocillin, piperacillin, aztreonam, norfloxacin, trimethoprim, ceftazidime, dapsone, neomycin, azithromycin, clarithromycin, amoxicillin, ciprofloxacin, and vancomycin.

Antiviral agents specifically or generally modulate the biological activity of viruses such as picornavirus, influenza virus, herpes viruses, herpes simplex, herpes zoster, enteroviruses, varicella and rhinovirus, which are associated with the common cold. Exemplary antiviral agents include acyclovir, trifluridine, idoxorudine, foscarnet, ganciclovir, zidovudine, dideoxycytosine, dideoxyinosine, dipyridamole, stavudine, cidofovir, famciclovir, valaciclovir, valganciclovir, acyclovir, didanosine, zalcitabine, rifimantadine, saquinavir, indinavir, ritonavir, ribavarin, nelfinavir, adefovir, nevirapine, delavirdine, efavirenz, abacavir, amantadine, emtricitabine, entecavir, tenofovir, zanamivir, oseltamivir, ICI 130,685, impulsin, pleconaril, penciclovir, vidarabine, cytokines, and combinations thereof.

Anti-inflammatories include salicylic acid derivatives including aspirin, paraminophenol derivatives including acetaminophen, indole and indene acetic acids including indomethacin, sulindac and etodalac, heteroaryl acetic acids including tolmetin diclofenac and ketorolac, aryl propionic acid derivatives including ibuprofen, naproxen, ketoprofen, fenopren, ketorlac, carprofen, oxaprozine, anthranilic acids including mefenamic acid, meclofenamic acid, and enolic acids including piroxicam, tenoxicam, phenylbutazone and oxyphenthatrazone.

Antacids include cimetidine, ranitidine, nizatidine, famotidine, omeprazole, bismuth antacids, metronidazole antacids, tetracycline antacids, clarthromycin antacids, hydroxides of aluminum, magnesium, sodium bicarbonates, calcium bicarbonate and other carbonates, silicates, phosphates, and combinations thereof.

Antifungal agents include, for example, ketoconazole, fluconazole, nystatin, itraconazole, clomitrazole, natamycin, econazole, isoconazole, oxiconazole, thiabendazole, tiaconazole, voriconazole, terbinafine, amorolfine, micfungin, amphotericin B, and combinations thereof.

Chemotherapeutics agents include cisplatin (CDDP), procarbazine, mechlorethamine, cyclophosphamide, camptothecin, ifosfamide, melphalan, chlorambucil, bisulfan, nitrosurea, dactinomycin, daunorubicin, doxorubicin, bleomycin, plicomycin, mitomycin, etoposide (VP16), tamoxifen, taxol, transplatinum, 5-fluorouracil, vincristin, vinblastin and methotrexate and analogs or derivative variants thereof, and combinations thereof.

Diuretics include but are not limited to acetazolamide, dichlorphenamide, methazolamide, furosemide, bumetanide, ethacrynic acid torseimde, azosemide, muzolimine, piretanide, tripamide, bendroflumethiazide, benzthiazide, chlorothiazide, hydrochlorothiazide, hydroflumethiazide, methyclothiazide, polythiazide, trichlormethiazide, indapamide, metolazone, quinethazone, amiloride, triamterene, sprionolactone, canrenone, potassium canrenoate, and combinations thereof.

Psychotherapeutic agents include thorazine, serentil, mellaril, millazine, tindal, permitil, prolixin, trilafon, stelazine, suprazine, taractan, navan, clozaril, haldol, halperon, loxitane, moban, orap, risperdal, alprazolam, chlordiaepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, welibutrin, serzone, desyrel, nardil, parnate, eldepryl, and combinations thereof.

Appetite suppressants include benzphetamine, diethylpropion, mazindol, phendimetrazine, phentermine, hoodia, ephedra, and caffeine. Additional appetite suppressant are commericailly under the following trade names: Adipex, Adipost, Bontril PDM, Bontril Slow Release, Didrex, Fastin, Ionamin, Mazanor, Melfiat, Obenix, Phendiet, Phendiet-105, Phentercot, Phentride, Plegine, Prelu-2, Pro-Fast, PT 105, Sanorex, Tenuate, Sanorex, Tenuate, Tenuate Dospan, Tepanil Ten-Tab, Teramine, Zantryl and combinations thereof.

Nutraceuticals and micronutrients include herbs and botanicals such as aloe, bilberry, bloodroot, calendula, capsicum, chamomile, cat's claw, echinacea, garlic, ginger, ginko, goldenseal, various ginseng, green tea, golden seal, guarana, kava kava, lutein, nettle, passionflower, rosemary, saw palmetto, St. John's wort, thyme, valerian, and combinations thereof. Also included are mineral supplements such as calcium, copper, iodine, iron, magnesium, manganese, molybdenum, phosphorous, zinc, selenium, and combinations thereof. Other nutraceuticals that can be added include fructo-oligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Vitamins and co-enzymes include water or fat-soluble vitamins such as thiamin, riboflavin, nicotinic acid, pyridoxine, pantothenic acid, biotin, folic acid, flavin, choline, inositol and paraminobenzoic acid, carnitine, vitamin C, vitamin D and its analogs, vitamin A and the carotenoids, retinoic acid, vitamin E, vitamin K, vitamin B₆, vitamin B₁₂, and combinations thereof. Combinations comprising at least one of the foregoing nutraceuticals can be used.

Specific optional, additional medicaments that can be used include caffeine, cimetidine, ranitidine, famotidine, omeprazole, dyclonine, nicotine, and combinations thereof.

The medicaments can be present in a suitable amount depending upon the suitable level of dosage for the desired purpose. In some embodiments, the medicaments are present in an amount of about 0.01 to about 2 weight percent of the chewing gum composition. Within the range of about 0.01 to about 2 weight percent, the medicaments can be about 0.05 to about 1.25 weight percent; specifically, the medicaments can be about 0.1 to 1 weight percent.

Anti-oxidants include natural and artificial anti-oxidants like beta-carotenes, acidulants e.g. Vitamin C, propylgallate, butyl hydroxyanisole, butylated hydroxytoluene, Vitamin E, Carnosic acid, Rosmanol, rosmaridiphenol, and the likes. The anti-oxidants can be present in a suitable amount depending upon the desired purpose. In some embodiments, the anti-oxidants are present in an amount of about 0.01 to about 2 weight percent of the chewing gum composition. Within the range of about 0.01 to about 2 weight percent, the anti-oxidants can be about 0.05 to about 1.25 weight percent; specifically, the anti-oxidants can be about 0.1 to 1 weight percent.

Preservatives include any natural and synthetic preservatives that improve shelf life of a chewing gum product. Suitable preservatives include propanoic acid, benzoic acid, and sorbic acid.

The relative amounts of each of the components of the chewing gum composition will depend on the identity of the particular component of the chewing gum composition, as well as, the desired flavor of the chewing gum composition, and are readily determined by one of ordinary skill in the art.

The gum compositions of the disclosed herein can be coated or uncoated, and be in the form of slabs, sticks, pellets, balls, and the like. The composition of the different forms of the gum compositions will be similar but can vary with regard to the ratio of the ingredients. For example, coated gum compositions can contain a lower percentage of softeners. Pellets and balls can have a chewing gum core, which has been coated with either a sugar solution or a sugarless solution to create the hard shell. Slabs and sticks are usually formulated to be softer in texture than the chewing gum core. In some cases, a hydroxy fatty acid salt or other surfactant active can have a softening effect on the gum base. In order to adjust for any potential undesirable softening effect that the surfactant active can have on the gum base, it can be beneficial to formulate a slab or stick gum having a firmer texture than usual (i.e., use less conventional softener than is typically employed).

Center-filled gum is another common gum form. The gum portion has a similar composition and mode of manufacture to that described above. However, the center-fill is typically an aqueous liquid or gel, which is injected into the center of the gum during processing. The center-filled gum can also be optionally coated and can be prepared in various forms, such as in the form of a lollipop.

In some embodiments, there is provided a method of preparing a chewing gum, the method comprising blending about 5 to about 90 weight percent of a water-insoluble gum base, about 0.1 to about 15 weight percent of an alternating copolymer of a C₂-C₁₀ alkene and maleic anhydride, and about 5 to about 50 weight percent of one or more additional ingredients selected from the group consisting of sweetening agents, flavor modulators or potentiators, flavorants, aroma agents, coolants, warming agents, coloring agents, medicaments, oral care agents, throat care agents, breath fresheners, mineral adjuvants, bulking agents, acidulants, buffering agents, warming agents, tingling agents, mouth moisteners, flavor enhancing composition, antioxidants, preservatives, and combinations thereof; wherein all weight percents are based on the total weight of the chewing gum composition. Within the range of about 5 to about 90 weight percent, the water-insoluble gum base amount can be about 10 to about 50 weight percent, specifically about 15 to about 40 weight percent, and more specifically about 20 to about 30 weight percent. The water-insoluble gum base can be present in an amount of about 5 to about 90 weight percent, including 5, 10, 15, 20, 25, 30, 35, 40, 45, 50, 55, 60, 65, 70, 75, 80, 85 and 90 weight percent. Within the range of about 0.1 to about 15 weight percent, the alternating copolymer amount can be about 0.5 to about 8 weight percent, specifically about 1 to about 6 weight percent, and more specifically from about 2 to about 4 weight percent. The alternating copolymer can be present in an amount of about 0.1 to about 15 weight percent, including 0.5, 1, 2, 3, 4, 5, 6, 7, 8, 9, 10, 11, 12, 13, 14 and 15 weight percent. Within the range of about 5 to about 50 weight percent, the one or more additional ingredients amount can be about 10 to about 40 weight percent, specifically about 15 to about 30 weight percent. The additional ingredients can be present in an amount of about 5 to about 50 weight percent, including 5, 10, 15, 20, 25, 30, 35, 40, 45 and 50 weight percent.

In some embodiments, the method of preparing a chewing gum composition comprises pre-blending the gum base and the alternating copolymer to form a gum base pre-blend, and blending the gum base pre-blend and the additional ingredients. In some other embodiments, the method of preparing chewing gum compositions comprises pre-blending the additional ingredients and the alternating copolymer to form an additional ingredient pre-blend, and blending the additional ingredient pre-blend and the gum base. It is preferred to prepare an additional ingredient pre-blend first and then blending it with a gum base. The present inventors found that a chewing gum composition prepared by blending an additional ingredient pre-blend and gum base possessed enhanced degradation properties as compared to a chewing gum composition prepared by blending a gum base pre-blend and additional ingredients. Without being bound by a theory, it is believed that when the alternating copolymer is pre-blended with additional ingredients, it is more uniformly distributed in the chewing gum composition and therefore provides enhanced degradation properties.

In some embodiments of the method of preparing a degradable chewing gum, the alternating copolymer is provided in a powder form comprising particles having mean particle size of about 1 micrometer to about 100 micrometers measured according to ASTM D1921-01. Within the range of 1 micrometer to 100 micrometers, the equivalent spherical diameter of the particles can be about 2 micrometers to about 80 micrometers, specifically about 5 micrometers to 60 micrometers and more specifically about 10 micrometers to about 40 micrometers. In some embodiments, the alternating copolymer is provided in an encapsulated form as described above.

The chewing gum compositions can be prepared using standard techniques and equipments known to those skilled in the art. The apparatus useful in accordance with some embodiments comprises mixing and heating apparatus well known in the chewing gum manufacturing arts, and therefore the selection of the specific apparatus will be apparent to the artisan.

In some embodiments, gum pieces can be coated with an aqueous coating composition, which can be applied by any method known in the art. The coating composition can be present in an amount of about 10 to about 50 weight percent of the total gum piece. Within the rage of about 10 to about 50 weight percent, the coating composition amount can be about 20 to about 40 weight percent, specifically about 25 to 35 weight percent.

The outer coating can be hard or crunchy. In some embodiments, the outer coating includes sorbitol, maltitol, xylitol, isomalt, or another crystallizable polyol. Sucrose can also be used. Flavorants can also be added to yield unique product characteristics.

The coating, if present, can include several opaque layers, such that the chewing gum composition is not visible through the coating itself, which can optionally be covered with a further one or more transparent layers for aesthetic, textural and protective purposes. The outer coating can also contain small amounts of water and gum arabic. The coating can be further coated with wax. The coating can be applied by successive applications of a coating solution, with drying in between each coat. As the coating dries it usually becomes opaque and is usually white, though other colorants can be added. A polyol coating can be further coated with wax. The coating can further include colored flakes or speckles.

The coating can be formulated to assist with increasing the thermal stability of the gum piece and preventing leaking of a liquid fill if the gum product is a center-filled gum. In some embodiments, the coating can include a gelatin composition. The gelatin composition can be added as a 40 weight percent aqueous solution and can be present in the coating composition about 5 to about 10 weight percent of the coating composition, and more specifically about 7 to about 8 weight percent of the coating solution. The gel strength of the gelatin can be about 130 bloom to about 250 bloom.

The foregoing and other embodiments are further illustrated by the following examples, which are not intended to limit the effective scope of the claims. All parts and percentages in the examples and throughout the specification and claims are by weight of the final composition unless otherwise specified.

### EXAMPLES

### Example 1 and Comparison 1

### Preparation and Testing for Degradation Properties

The experiments described below illustrate the surprising finding that addition of a copolymer of an alkene and maleic anhydride to a chewing gum provides degradation properties of the chewing gum.

Chewing gum compositions with and without alternating alkene-maleic anhydride copolymer were prepared. The chewing gum compositions were prepared by first preparing a pre-blend. The pre-blend was prepared by blending the ethylene maleic anhydride alternating copolymer with the additional ingredients listed in Table 1. Since the Comparison 1 chewing gum does not include any alternating copolymer, pre-blending was not necessary. Later, the gum base was melted at a temperature of about 175° C. Once melted and placed in a standard mixer, the pre-blend was added and thoroughly mixed for about 20 minutes. For preparing Comparison 1, the molten gum base was mixed with the additional ingredients. The resulting mix then is formed into the desired final shape by extrusion followed by pressing into tablet form.

The compositions are summarized in Table 1. An alternating copolymer of ethylene and maleic anhydride having a weight average molecular weight of about 100,000 to 500,000 atomic mass units was obtained from Aldrich.

TABLE 1
Compositions of Example 1 and Comparison 1 Chewing Gums

| | % by weight | |
|---|---|---|
| Component | Example 1 | Comparison 1 |
| Gum base | 28 | 28 |
| Lecithin | 0.5 | 0.5 |
| Acyetylated monoglycerides, distilled | 0.5 | 0.5 |
| Sorbitol | 40 | 41.5 |
| Mannitol | 5 | 5 |
| Xylitol | 9.5 | 9.5 |
| Glycerin | 4.75 | 4.75 |
| Ethylene-Maleic anhydride copolymer^{#1} | 1.5 | 0 |
| Colorant^{#2} | 0.04 | 0.04 |
| Liquid flavor^{#3} | 3.1 | 3.1 |
| Cooling compound^{#4} | 0.06 | 0.06 |
| Powdered flavor^{#5} | 1.5 | 1.5 |
| Encapsulated citric acid^{#6} | 0.75 | 0.75 |
| Encapsulated malic acid^{#7} | 0.75 | 0.75 |
| Aspartame | 0.3 | 0.3 |
| Acesulfame potassium salt (milled) | 0.15 | 0.15 |
| Encapsulated aspartame^{#8} | 2.4 | 2.4 |
| Encapsulated acesulfame Potassium salt^{#9} | 1.2 | 1.2 |

^{#1}Commercially available from Sigma-Aldrich, product number 188050
^{#2}FD & C yellow No. 5
^{#3}Available from Takasago Inc. as product number TEG-10332015
^{#4}WS-3
^{#5}Available from Takasago Inc. as product number TEG-10331914 a
^{#6}Available from BALCHEM CONFECSHURE under trade name 396AD0A878
^{#7}Available from BALCHEM CONFECSHURE under trade name 573 AD0A878
^{#8}Encapsulated with polyvinyl acetate
^{#9}Encapsulated with polyvinyl acetate

Individual pieces of each of the finished gum products of Example 1 and Comparison 1 were placed in an Erweka DRT-1 chewing gum machine between two nylon nets. The gap between the jaws was set to 2.5 mm. The pieces then were chewed mechanically at 40 strokes per minute for 30 minutes in 20 milliliters of 0.1 mole per liter sodium phosphate buffer at pH 8.0 (to simulate the pH of the mouth) to form cuds.

Chewed gum cuds of Example 1 and Comparison 1 were left on a wet indoor concrete slab for 7 days. The wet indoor concrete slab simulates the environmental conditions. The slab was stored at 25 degrees Celsius at a relative humidity of 40-55%. 150 milliliters of water was evenly sprayed on the slab per day. The slab had 15 chewed cud samples, so each cud sample was exposed to approximately 10 milliliters of water each day.

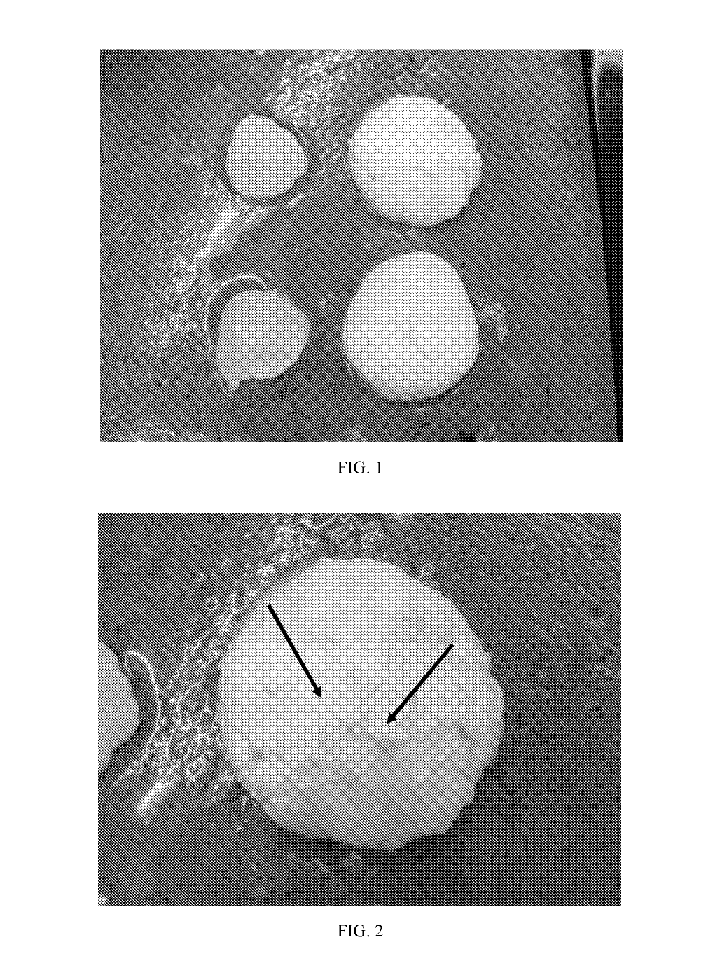

FIG. 1 shows chewed cuds of the Example 1 and the Comparison 1 after 7 days on a wet indoor concrete slab. The two samples on right are Example 1 chewed cuds while the two samples on left are Comparison 1 chewed cuds. It is clearly evident from FIG. 1 that the chewed cuds of the Example 1 absorbed substantially more water than the chewed cuds of the Comparison 1. FIG. 2 shows an enlarged image of the chewed cud of the Example 1 chewing gum. This chewed cud exhibits formation of hydrogels which can be observed in FIG. 2. Some hydrogel areas are indicated by arrows in the figure. The hydrogel-containing cud loses much of its viscoelastic properties and is broken down easily with mild physical force. Such hydrogel formation is not observed in the Comparison 1 chewing gum cud. The Comparison chewing gum cud maintains its viscoelastic properties and continues to remain sticky.

To further illustrate the water absorption properties of the Example 1 gum, another chewed cud of Example 1 gum was exposed to simulated environmental conditions for nine days. The environmental simulation was carried out by placing the cud samples on a wet indoor concrete slab as described above. Each cud sample was exposed to about 10 milliliters of water each day.

FIG. 3 shows the amount of water absorbed by chewed cud of the Example 1 chewing gum over time, as well as images of the chewed cud at the respective time points. By the seventh day, the cud had absorbed over 3 grams of water and showed formation of hydrogels. The cud was found susceptible to degradation by mild physical force (e.g., footfall).

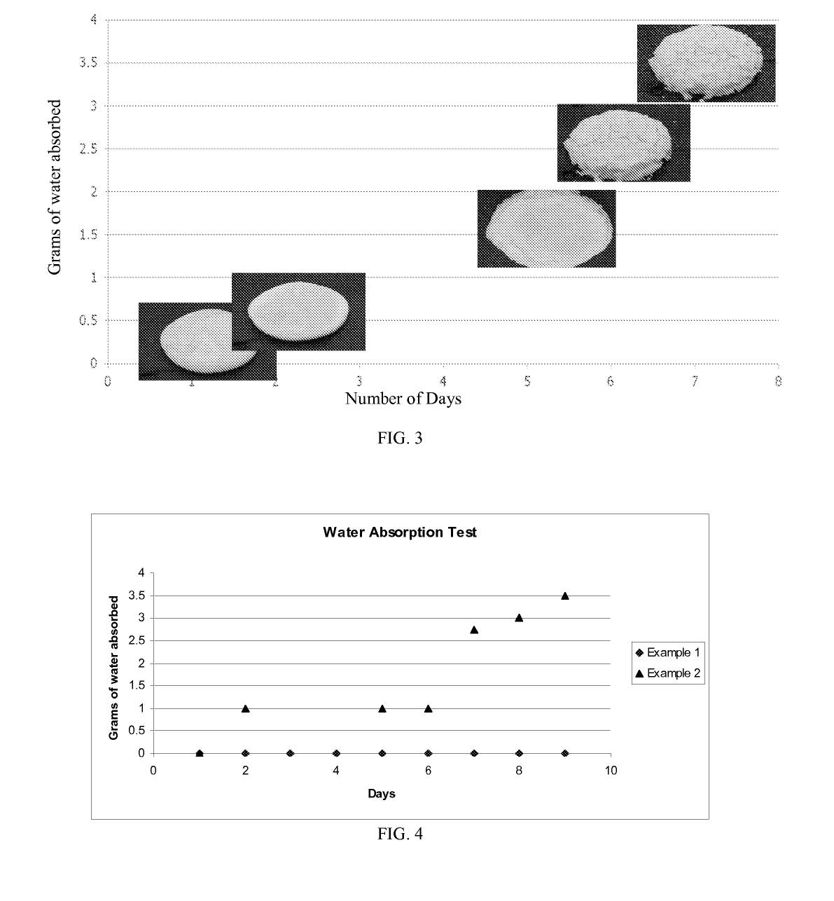

To quantify water absorption properties of inventive chewing gums, another experiment was conducted. Chewing gum cuds of Comparison 1 and Example 1 were mechanically chewed as described above. Both chewing gum cuds were placed on an absorbent surface and exposed to 10 milliliters of water each day, the cud and the absorbent surface were drained of excess water and weighed daily. FIG. 4 plots the amount of water taken up on average of four cuds of each example type over the test time. The results show that the Example 1 chewing gum cud absorbed about 3.5 grams of water or about 700 weight percent based on the initial cud weight of 0.5 grams. On the other hand, the Comparison 1 chewing gum did not absorb any significant amount of water under the same conditions.

### Examples 2-7 and Comparison 2

### Sugarless Chewing Gum Compositions

Seven representative sugarless chewing gum compositions are summarized in Table 2. Six of the compositions (Examples 2-7) are inventive compositions containing an alternating copolymer of an alkene and maleic anhydride. The seventh composition (Comparison 2) is a comparative composition that does not include any alternating copolymer of an alkene and maleic anhydride.

TABLE 2
Sugarless Chewing Gum Compositions

| | % by weight | | | | | | |
|---|---|---|---|---|---|---|---|
| Component | Ex. 2 | Ex. 3 | Ex. 4 | Ex. 5 | Ex. 6 | Ex. 7 | Comp. 2 |
| Gum base | 25-35 | 25-35 | 25-35 | 25-35 | 25-35 | 25-35 | 25-35 |
| Sorbitol | 40-50 | 40-50 | 40-50 | 40-50 | 40-50 | 40-50 | 40-50 |
| Maltitol | 8-12 | 8-12 | 8-12 | 8-12 | 8-12 | 8-12 | 8-12 |
| Peppermint | 2-5 | 2-5 | 2-5 | 2-5 | 2-5 | 2-5 | 2-5 |
| flavor | | | | | | | |
| Glycerin | 2-7 | 2-7 | 2-7 | 2-7 | 2-7 | 2-7 | 2-7 |
| Acesulfame K | 0.05-0.2 | 0.05-0.2 | 0.05-0.2 | 0.05-0.2 | 0.05-0.2 | 0.05-0.2 | 0.05-0.2 |
| Aspartame | 0.05-0.4 | 0.05-0.4 | 0.05-0.4 | 0.05-0.4 | 0.05-0.4 | 0.05-0.4 | 0.05-0.4 |
| Calcium | 2-7 | 2-7 | 2-7 | 2-7 | 2-7 | 2-7 | 2-7 |
| Caronate | | | | | | | |
| Poly(alkene-alt- | 1 | 3 | 5 | 7 | 9 | 10 | 0 |
| maleic | | | | | | | |
| anhydride) | | | | | | | |
| Total | 100 | 100 | 100 | 100 | 100 | 100 | 100 |

The chewing gum compositions are prepared by first preparing a pre-blend. The pre-blend is prepared by blending the alternating copolymer of an alkene and maleic anhydride with the additional ingredients. Later, the gum base is melted at a temperature of about 150-175° C. Once melted and placed in a standard mixer, the pre-blend is added and thoroughly mixed for about 1 to about 20 minutes. The resulting mix then is formed into the desired final shape by employing conventional techniques, e.g., extrusion, rolling and cutting into sticks, casting into pellets and then optionally coating, or pressing into tablets, among others.

### Examples H-N

### Sugar-Sweetened Chewing Gum Compositions

Seven representative sugar-sweetened chewing gum compositions are summarized in Table 3. Six of the compositions (Examples 8-13) are inventive compositions containing an alternating copolymer of an alkene and maleic anhydride. The seventh composition (N) is a comparative composition that does not include any alternating copolymer of an alkene and maleic anhydride.

TABLE 3
Sugar Containing Chewing Gum Compositions

| | % by weight | | | | | | |
|---|---|---|---|---|---|---|---|
| Component | Ex. 8 | Ex. 9 | Ex. 10 | Ex. 11 | Ex. 12 | Ex. 13 | Comp. 3 |
| Gum base | 25-35 | 25-35 | 25-35 | 25-35 | 25-35 | 25-35 | 25-35 |
| Corn Syrup | 10-20 | 10-20 | 10-20 | 10-20 | 10-20 | 10-20 | 10-20 |
| (glucose) | | | | | | | |
| Sugar | 50-60 | 50-60 | 50-60 | 50-60 | 50-60 | 50-60 | 50-60 |
| pulverized | | | | | | | |
| Natural | 1-4 | 1-4 | 1-4 | 1-4 | 1-4 | 1-4 | 1-4 |
| Peppermint Oil | | | | | | | |
| Poly(alkene-alt- | 1 | 3 | 5 | 7 | 9 | 10 | 0 |
| maleic | | | | | | | |
| anhydride) | | | | | | | |
| Total | 100 | 100 | 100 | 100 | 100 | 100 | 100 |

The chewing gum compositions are prepared as described for Examples 2-7.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A degradable chewing gum composition comprising:
about 5 to about 90 weight percent of a water-insoluble gum base; and
about 0.1 to about 15 weight percent of an alternating copolymer of a C₂-C₁₀ alkene and maleic anhydride;
wherein all weight percents are based on the total weight of the chewing gum composition.

2. The chewing gum composition of claim 1, comprising about 10 to about 50 weight percent of the water-insoluble gum base.

3. The chewing gum composition of claim 1, comprising about 1 to about 5 weight percent of the alternating copolymer.

4. The chewing gum composition of claim 1, wherein the C₂-C₁₀ alkene is selected from the group consisting of ethylene, propylene, 1-butene, 1-pentene, 1-hexene, 1-heptene, 1-octene, 1-nonene, 1-decene, and mixtures thereof.

5. The chewing gum composition of claim 1, wherein the C₂-C₁₀ alkene is ethylene.

6. The chewing gum composition of claim 1, wherein the alternating copolymer has a weight average molecular weight of about 10,000 to about 3,000,000 atomic mass units.

7. The chewing gum composition of claim 1, wherein the alternating copolymer is present in a powder form comprising particles having mean particle size of about 1 micrometer to about 100 micrometers measured according to ASTM D1921-01.

8. The chewing gum composition of claim 1, wherein the alternating copolymer is present in a powder form comprising particles having mean particle size of about 10 micrometers to about 40 micrometers measured according to ASTM D1921-01.

9. The chewing gum composition of claim 1, wherein the alternating copolymer is present in an encapsulated form.

10. The chewing gum composition of claim 1, comprising about 1 to about 5 weight percent of the alternating copolymer, wherein the C₂-C₁₀ alkene comprises ethylene.

11. The chewing gum composition of claim 1, further comprising about 5 to about 50 weight percent of one or more additional ingredients selected from the group consisting of sweetening agents, flavor modulators, flavor potentiators, flavorants, aroma agents, coolants, warming agents, coloring agents, breath fresheners, mouth moisteners, humectants, acidulants, buffering agents, tingling agents, oral care agents, throat care agents, medicaments, mineral adjuvants, bulking agents, antioxidants, preservatives, and combinations thereof.

12. The chewing gum composition of claim 1, wherein a cud of the chewing gum composition upon chewing by Erweka DRT-1 chewing gum machine at 40 strokes per minute for 30 minutes in 20 milliliters of 0.1 mol/liter sodium phosphate buffer at pH of 8, absorbs water in an amount of at least 5 times its own weight.

13. A degradable method of preparing a chewing gum composition comprising:
blending
about 5 to about 90 weight percent of a water-insoluble gum base,
about 0.1 to about 15 weight percent of an alternating copolymer of a C₂-C₁₀ alkene and maleic anhydride, and
about 5 to about 50 weight percent of one or more additional ingredients selected from the group consisting of sweetening agents, flavor modulators, flavor potentiators, flavorants, aroma agents, coolants, warming agents, coloring agents, breath fresheners, mouth moisteners, humectants, acidulants, buffering agents, tingling agents, oral care agents, throat care agents, medicaments, mineral adjuvants, bulking agents, antioxidants, preservatives, and combinations thereof.

14. The method of claim 13, wherein said blending comprises pre-blending the gum base and the alternating copolymer to form a gum base pre-blend, and blending the gum base pre-blend and the additional ingredients.

15. The method of claim 13, wherein said blending comprises pre-blending the additional ingredients and the alternating copolymer to form an additional ingredient pre-blend, and blending the additional ingredient pre-blend and the gum base.

16. The method of claim 13, wherein the alternating copolymer is present in a powder form comprising particles having mean particle size of about 1 micrometer to about 100 micrometers measured according to ASTM D1921-01.

17. The method of claim 13, wherein the alternating copolymer is present in a powder form comprising particles having mean particle size of about 10 micrometers to about 40 micrometers measured according to ASTM D1921-01.

18. The method of claim 13, wherein the alternating copolymer is provided in an encapsulated form.
